(19) United States
(12) Patent Application Publication
(10) Pub. No.: US 2016/0245964 A1
(43) Pub. Date: Aug. 25, 2016

(54) OPTICAL SCATTERER COMPRISING A SCATTERING PORTION FORMED FROM A FOAM COMPRISING AT LEAST ONE FLUOROPOLYMER

(71) Applicant: ARKEMA FRANCE, Colombes (FR)

(72) Inventors: Thomas FINE, Shanghai (CN); Saeid ZERAFATI, Villanova, PA (US)

(21) Appl. No.: 15/026,284

(22) PCT Filed: Sep. 30, 2014
(86) PCT No.: PCT/FR2014/052454

§ 371 Date: Mar. 31, 2016

(30) Foreign Application Priority Data
Oct. 1, 2013 (FR) 1359477

(51) Int. Cl. G02B 5/02

(52) U.S. Cl. CPC G02B 5/0247; G02B 5/0278

(57) ABSTRACT

The present invention relates to an optical scatterer having a scattering portion able to be passed through by the light flux emitted by a point light source, when said optical scatterer is mounted on said point light source. According to the invention, characteristically, said scattering portion is formed from a solid foam comprising at least one fluoropolymer.

The present invention relates to an optical diffuser, especially an optical diffuser that can be used for a point light source such as, for example an LED, and also a light-emitting device comprising a point light source associated with the aforementioned optical diffuser.

A point light source creates a light zone having a determined shape that can be identified with the naked eye. The shape of the light-emitting zone remains visible and it is therefore essential, for certain uses, to mask this shape by creating a halo of more diffuse light. For example, when point light sources are used to form an image, the individualization of the light sources creates the phenomenon referred to as “pixellization” which reduces the quality of the image, the latter appearing as a set of light spots.

LEDs (light-emitting diodes), which are point light sources, are increasingly preferred. over incandescent or fluorescent light sources due to their low energy consumption. LEDs are used, for example, as light sources on motor vehicles, for indicating panels, luminous displays and street lighting.

Nevertheless, LEDs produce a very bright, slightly harsh light spot, which is often dazzling. The light from LEDs is not therefore comfortable for the user and it is necessary to use, in many applications, an optical diffuser that reduces the brightness of LEDs.

Furthermore, LEDs, in particular LEDs that produce a high luminous flux, create a unidirectional light beam, the emission spectrum of which is specific. Not all optical diffusers may therefore be suitable for LEDs.

Optical diffusers (also referred to as lenses) are generally made of plastic. They are designed to be used with a point light source and have a diffusing portion. The diffusing portion is positioned close to the point light source when the optical diffuser is mounted on the latter. The diffusing portion is then passed through by the light emitted by the point light source. The role of the optical diffusers is to protect the point light source while providing a satisfactory transmission of the light emitted by the latter. They also make it possible to obtain a diffusion of the light emitted by the point light source, thus reducing the glare generated and preventing the aforementioned pixelization phenomenon.

Document WO 2006/100126 describes an optical diffuser made of thermoplastic material which contains particles that make it possible to scatter the light.

One objective of the present invention is to propose an optical diffuser that can be used, especially with a point light source, in particular an LED, which provides good transmission of the light and which has a satisfactory hiding power.

Another objective of the present invention is to propose an optical diffuser for a point light source that is easy to produce and has a low cost.

Another object of the present invention is to propose an optical diffuser that has good resistance to fire and to heat, especially to the heat released by the point light source.

Another object of the present invention is to propose an optical diffuser that is transparent to UV rays and which is relatively chemically inert. The expression “chemically inert” is understood to mean the fact that it withstands acid and/or basic attacks, thus allowing exposure to adverse weather conditions.

In order to achieve at least one of the aforementioned objectives, the present invention proposes an optical diffuser capable of being mounted on a point light source and which has a diffusing portion that is passed through by the luminous flux emitted by a point light source, when said optical diffuser is mounted on the latter. Characteristically, according to the invention, said diffusing portion is formed from a solid foam comprising at least one fluoropolymer.

Indeed, it is to the credit of the applicant to have demonstrated that the use of a foam such as mentioned above, makes it possible, owing to the presence of bubbles, to obtain a satisfactory diffusion of the light without significant loss in the degree of transmission of the latter.

The use of a foam makes it possible, furthermore, to reduce the amount of polymer used, which lightens the optical diffuser and reduces the cost thereof.

Regarding the fluoropolymer, this denotes any polymer obtained from at least one monomer selected from compounds containing a vinyl group capable of opening in order to polymerize and which contains, directly attached to this final group, at least one fluorine atom, a fluoroalkyl group or a fluoroalkoxy group.

As examples of monomer, mention may be made of vinyl fluoride, vinylidene fluoride (VDF, CH₂═CF₂); trifluoroethylene (VF₃); chlorotrifluoroethylene (CTFE); 1,2-difluoroethylene; tetrafluoroethylene (TFE); hexafluoropropylene (HFP); perfluoro(alkyl vinyl) ethers such as perfluoro(methyl vinyl) ether (PPVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n=1, 2, 3, 4 or 5; the product of formula R₁CH₂OCFCF₂ in which R₁ is hydrogen or F(CF₂)_{z} and z=1, 2, 3 or 4; the product of formula R₃OCF═CH₂ in which R₃ is F(CF₂)_{z}— and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer, it may also comprise non-fluorinated monomeric units such as ethylene or propylene.

By way of example, the fluoropolymer may be selected from:
homopolymers and copolymers of vinylidene fluoride (VDF, CH₂═CF₂) containing at least 50% by weight of VDF; the comonomer of VDF may be selected from chlorotrifluoroethylene (CTFE), hexafluoropropylene (HFP), trifluoroethylene (VF) and tetrafluoroethylene (TFE);
copolymers of TFE and ethylene (ETFE);
homopolymers and copolymers of trifluoroethylene (VF₃);
copolymers of EFEP type combining VDF and TFE (especially the EFEPs from Daikin);
copolymers, and especially terpolymers, combining the residues of the chlorotrifluoroethylene (CTFE), tetrafluoroethylene (TFE), hexafluoropropylene (HFP) and/or ethylene units and optionally of the VDF and/or VF₃ units. Advantageously, the fluoropolymer consists of a PVDF homopolymer or of a copolymer prepared by copolymerization of vinylidene fluoride (VDF, CH₂—CF₂) with a fluorinated comonomer selected from: vinyl fluoride; trifluoroethylene (VF3); chlorotrifluoroethylene (CTFE); bromotrifluoroethylene; 1,2-difluoroethylene; tetrafluoroethylene (TFE); hexafluoropropylene (HFP); perfluoro(alkyl vinyl) ethers such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD), tetrafluoropropene; chlorotrifluoropropene; 3,3,3-trifluoropropene; pentafluoropropene; 2-chloro-3,3,3-trifluoropropene; the product of formula CF₂═CFOCF₂CF(CF₃)OCF₂CF₂X in which X is SO₂F, CO₂H, CH₂OH; CH₂OCN or CH₂OPO₃H, the product of formula CF₂═CFOCF₂CF₂SO₂F; the product of formula F(CF₂)ₙCH₂OCF═CF₂ in which n is equal to 1, 2, 3, 4 or 5; the product of formula R₁CH₂OCF═CF₂ in which R₁ is hydrogen or F(CF₂)_{z} and z is equal to 1, 2, 3 or 4; the product of formula R₃OCF═CH₂ in which R₃ is F(CF₂)_{z} and z is equal to 1, 2, 3 or 4; perfluorobutylethylene (PFBE); fluoroethylenepropylene (FEP); 2-trifluoromethyl-3,3,3-trifluoro-1-propene; 2,3,3,3-tetrafluoropropene or HFO-1234yf; E-1,3,3,3-tetrafluoropropene or HFO-1234zeE; Z-1,3,3,3-tetrafluoropropene or HFO-1234zeZ; 1,1,2,3-tetrafluoropropene or HFO-1234yc; 1,2,3,3-tetrafluoropropene or HFO-1234ye; 1,1,3,3-tetraftuoropropene or HFO-1234zc; chlorotetrafluoropropene or HCFO-1224.

Preferably, the aforementioned fluorinated comonomer is selected from chlorotrifluoroethylene (CTFE), hexafluoropropylene (HFP), trifluoroethylene (VF3), tetrafluoroethylene (TFE) and mixtures thereof.

The comonomer is advantageously HFP. Preferably, the copolymer comprises only VDF and HFP.

Preferably, the fluorinated copolymers are copolymers of VDF such as VDF-HFP containing at least 50% by weight of VDF, advantageously at least 75% by weight of VDF and preferably at least 80% by weight of VDF. For example, mention may more particularly be made of the copolymers of VDF containing more than 75% of VDF and the balance of HFP sold by ARKEMA under the name KYNAR FLEX®.

The fluoropolymer foam may advantageously comprise, in addition, an acrylic polymer as long as this is miscible with said fluoropolymer. Such a foam has an excellent resistance to heat and to flames. Furthermore, since acrylic polymers are less expensive than fluoropolymers, an optical diffuser is thus obtained, at lower cost, that has good optical properties and an excellent fire resistance. Polymethyl methacrylate, which is not very expensive, may advantageously be added to the fluoropolymer. Polyacrylic acids (PAAs), polyacrylates, polyacrylamide (PAM), polyalkyl acrylates such as polymethyl acrylate (PMA), polyethyl acrylate (PEA) and polybutyl acrylate (PBA) may be mentioned as examples of acrylic polymers. Generally an acrylic polymer denotes, within the meaning of the present invention, a polymer of general formula (—CH₂—CHCOOR—)ₙ, in which R is a hydrogen atom or an alkyl radical containing from 1 to 20 carbon atoms.

Advantageously, the foam contains a weight fraction of an acrylic polymer of between 0.1 and 90%, preferably between 5 and 50%, and more preferably still between 5 and 30% relative to the total weight of the acrylic polymer-vinylidene fluoride mixture. The aforementioned value is given by way of example, a person skilled in the art being capable of adjusting the fraction of acrylic polymer as a function of the fire resistance desired for the final product or of the desired chemical resistance or of the desired transparency to UV rays.

Advantageously, said acrylic polymer is a polymethyl methacrylate.

Advantageously, said foam contains, in addition, at least one additive selected from flame retardants, dyes, plasticizers, pigments, antioxidants, antistatic agents, surfactants and impact modifiers.

The method of manufacturing the foam is not limited according to the invention. It may be obtained by emulsion, suspension, injection of a gas, use of a nucleating agent, use of a compound that generates a gas by chemical reaction or other means. The foam obtained may be injected, injection-molded or extruded, then optionally laminated in order to form the diffusing portion of the diffuser of the invention or the diffuser itself.

Advantageously, at least the diffusing portion of the optical diffuser of the invention is obtained by extrusion or by injection. The method of manufacturing the foam and the optical diffuser itself are not limiting with respect to the present invention.

The shape of the optical diffuser is not limited according to the invention. It may be colored and/or have a pattern.

Advantageously, the diffusing portion has a thickness substantially equal to or greater than 100 μm and substantially less than or equal to 2 mm. More advantageously still, the diffusing portion has a thickness substantially equal to or greater than 150 μm and substantially less than or equal to 1 mm.

Advantageously, the diffusing portion has a hiding power HP(5.1) % measured according to the integrating sphere method that is substantially equal to or greater than 80% and in particular substantially equal to 90%.

Advantageously, the diffusing portion transmits, in the wavelengths of the visible spectrum, at least 50% and preferably at least 65% of the light emitted by said point light source. The aforementioned values are obtained according to the standard ASTM D1003.

The present invention also relates to a light-emitting device comprising a point light source and an optical diffuser according to the invention.

According to one embodiment, said point light source is a light-emitting diode.

### Definitions

A “point light source” is defined, within the meaning of the present invention, as being any source of electromagnetic radiation having a wavelength substantially greater than or equal to 4000 Angstrom and substantially less than or equal to 7700 Angstrom. Incandescent and fluorescent point light sources, neon and argon light sources and LEDs (light-emitting diodes) may be mentioned as non-limiting examples of a point light source.

A light-emitting device is defined, within the meaning of the present invention, as being the combination between a point light source and an optical diffuser.

The hiding power HP(n) % is defined as being measured according to the integrating sphere method described below.

The expression “solid foam” denotes a solid containing a multitude of bubbles and/or cavities of more or less homogeneous size and that are distributed more or less uniformly throughout the volume occupied by the foam, These hubbies or cavities may or may not communicate with one another.

The term “polymer” covers, within the meaning of the present invention, homopolymers, copolymers, especially statistical copolymers, alternating copolymers, block copolymers and branch copolymers. The term “copolymer” encompasses the polymers as mentioned above obtained from at least two different monomers or from at least one monomer and from at least one polymer. The copolymers according to the invention may thus be terpolymers, i.e. polymers obtained from a mixture containing three monomers, or from a mixture containing two monomers and one polymer or from a mixture containing one monomer and two polymers. The copolymers according to the invention may also be copolymers obtained from more than three different monomers and/or polymers.

The expression “monomeric unit” is understood within the meaning of the present invention to mean that the polymer comprises, in its longest chain, the molecule of said monomer bonded to another molecule of the same monomer or to a molecule of another monomer or polymer. The molecule of said monomer is denoted by the expression “monomeric unit”.

The acronym “PVDF” denotes a vinylidene fluoride polymer; the term “polymer” corresponding to the aforementioned definition.

### FIGURES

FIG. 1 represents the hiding power HP(5.) % measured at 5.1 cm as a function of the degree of transmission of the light (for a light at 23° C. emitted by a standard A illuminant) measured according to the standard ASTM D 1003, respectively for a sheet of non-foamed PVDF having a thickness of 1143 μm and for a sheet of foamed PVDF having a thickness of 381 μm;

FIG. 2 represents the hiding power HP(5.1) % measured at 5.1 cm as a function of the degree of transmission of the light (for a light at 23° C. emitted by a standard A illuminant) measured according to the standard ASTM D 1003, for a sheet of foamed PVDF having a thickness of 381 μm and for a sheet of non-foamed PVDF having a thickness of 762 μm;

FIG. 3 represents the hiding power HP(5.1) % measured at 5.1 cm as a function of the degree of transmission of the light (for a light at 23° C. emitted by a standard A illuminant) measured according to the standard ASTM D 1003, for a sheet of foamed PVDF having a thickness of 381 μm and for a sheet of non-foamed PVDF having the same thickness; and

FIG. 4 represents the degree of transmission of the light as a function of the wavelength of the latter, respectively for a PVDF foam sheet having a thickness equal to 355.6 μm, for a transparent Plexiglas® lens and for a PVDF foam sheet having a thickness equal to 165.1 μm.

### EXPERIMENTAL SECTION

### Method for Measuring the Hiding Power HP(n) %

The method for measuring the hiding power implemented throughout the present application uses a Perkin Elmer Lambda 950 device or a device of the BYK-Gardner haze meter type. Any other equivalent device may also be used. This method, referred to as the “integrating sphere method”, makes it possible to determine the amount of light “lost” in the axis of a light beam, by diffusion on passing into the diffusing portion of the optical diffuser to be studied. For this, two measurements are carried out for a same given range of wavelengths. For the first measurement, use is made of a light source that emits at the given wavelength and that is positioned at a determined distance from an integrating sphere that measures all the luminous flux that it receives. The diffusing portion of the optical diffuser to be studied is placed just at the entry of the sphere and the luminous flux transmitted through said diffusing portion is thus measured (according to the standard ASTM D1003); a value T0 (%) is thus obtained.

For the second measurement, the diffusing portion of the optical diffuser to be studied is placed at a distance n upstream of the integrating sphere, the point light source-integrating sphere distance and the emission spectrum of the point light source remain unchanged (same range of wavelengths); under these conditions, a portion of the light emitted by the light source is diffused by the diffusing portion of the optical diffuser, outside of the integrating sphere, and the latter measures, in theory, only the light transmitted in the axis of the entry of the integrating sphere. A value T(n) (%) is thus obtained. The hiding power HP(n) % (HP for hiding power) measured at a distance n is defined, within the meaning of the present invention, as follows:

HP(n) %=1−(T(n)/T0) with n=distance between the entrance of the integrating sphere and the diffusing portion of the diffuser to be studied, measured in cm.

It is considered that the hiding power is satisfactory if it is at least equal to 40% for n =5.1 cm; below 40%, a point light source, especially an LED, appears as a light spot, at a distance of 5.1 cm from the latter. When HP(5.1) % is greater than 95%, the degree of transmission of the light is compromised, reducing the lumen/watt consumed ratio.

### Influence of Foaming on the Hiding Power

The experiments that follow were carried out using sheets of KYNAR FLEX® foam (density d=1.78) obtained by extrusion. The 380 μm thick sheet thus has a density of 1.48, the 508 μm thick sheet has a density of 1.42 and the 762 μm thick sheet has a density of 1.19.

KYNAR FLEX® is a copolymer of VDF containing more than 75% of VDF and the balance of HFP sold by ARKEMA. The designation “foamed KYNAR FLEXR” corresponds to a solid KYNAR FLEX® foam. The light source is an illuminant of type A as defined by the international Commission on Illumination.

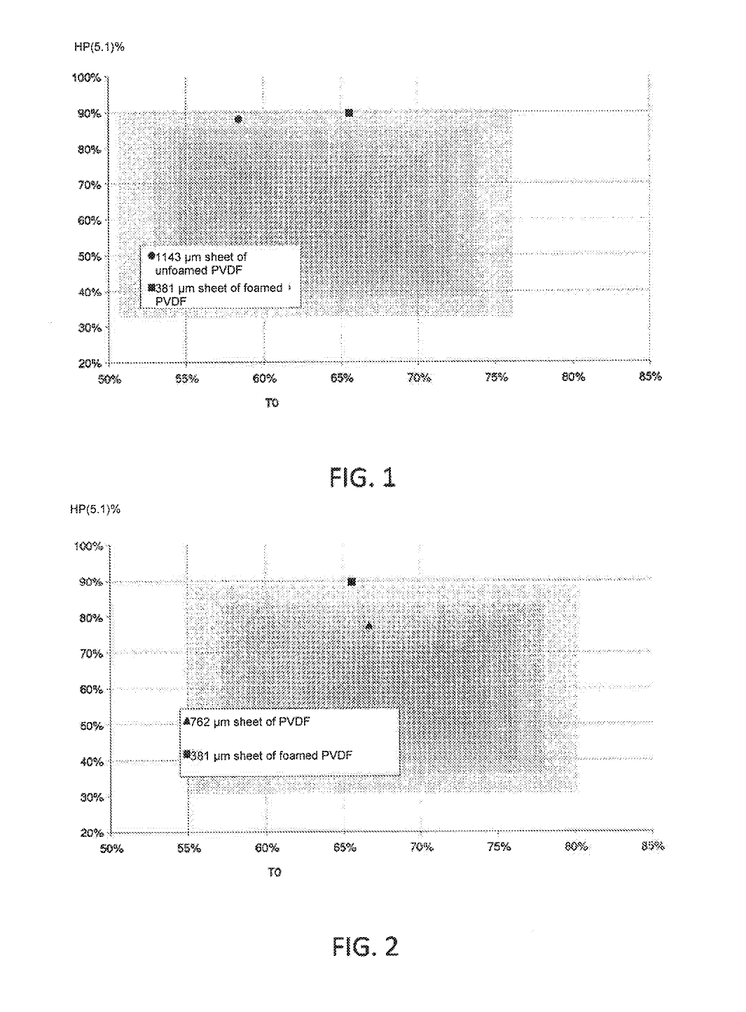

The values of the hiding power HP % are obtained for FIGS. 1 to 3 by means of a BYK-Gardner haze meter.
As can be seen in FIG. 1, the use of a fluoropolymer foam makes it possible to reduce the thickness of the diffusing portion without reducing the hiding power. Indeed, the sheet of unfoamed KYNAR FLEX® having a thickness equal to 1143 μm has a hiding power HP(5.1) % substantially equal to 87% whereas the sheet of KYNAR FLEX® foam having a thickness equal to 381 μm itself has a hiding power HP(5.1) % that is higher (90%). The gain in weight is obvious. The 1143 μm sheet corresponds to 2035 g/m² whereas the 381 μm foam corresponds to 564 g/m².

Furthermore, the results from FIG. 1 also show that the diffusing portion made of fluoropolymer foam transmits more light (T0=67%) than the one produced with the same fluoropolymer but not in the form of a foam (T0=56%).

The use of a fluoropolymer foam, in particular a vinylidene fluoride polymer foam, for the manufacture of the diffusing portion of an optical diffuser therefore makes it possible to reduce the thickness of the diffusing portion without reducing the hiding power, in particular hiding power measured as mentioned above at 5.1 cm (HP(5.1)%). The reduction in thickness is furthermore accompanied by a greater transmission of light.

As represented in FIG. 2, for substantially the same value of TO equal to 66%, the sheet of fluoropolymer foam has a better hiding power (78% for unfoamed KYNAR FLEX® versus 90% for the KYNAR FLEX® foam). These results clearly show that for the same transmittance, it is possible to obtain a greater hiding power HP(5.1) % by using a fluoropolymer foam, in particular a polyvinylidene fluoride foam.

With reference to FIG. 3, it is observed that the sheet of fluoropolymer foam has a hiding power HP(5.1) % of 90% whereas the sheet formed from the same unfoamed fluoropolymer has a hiding power HP(5.1) % of only 35%, for the same thickness. The bubbles of the foam therefore make it possible to increase the hiding power by diffusing the light while retaining a degree of transmission that is acceptable for a use as a diffusing portion of an optical diffuser.

### Influence of Foaming on the Degree of Transmission of Light

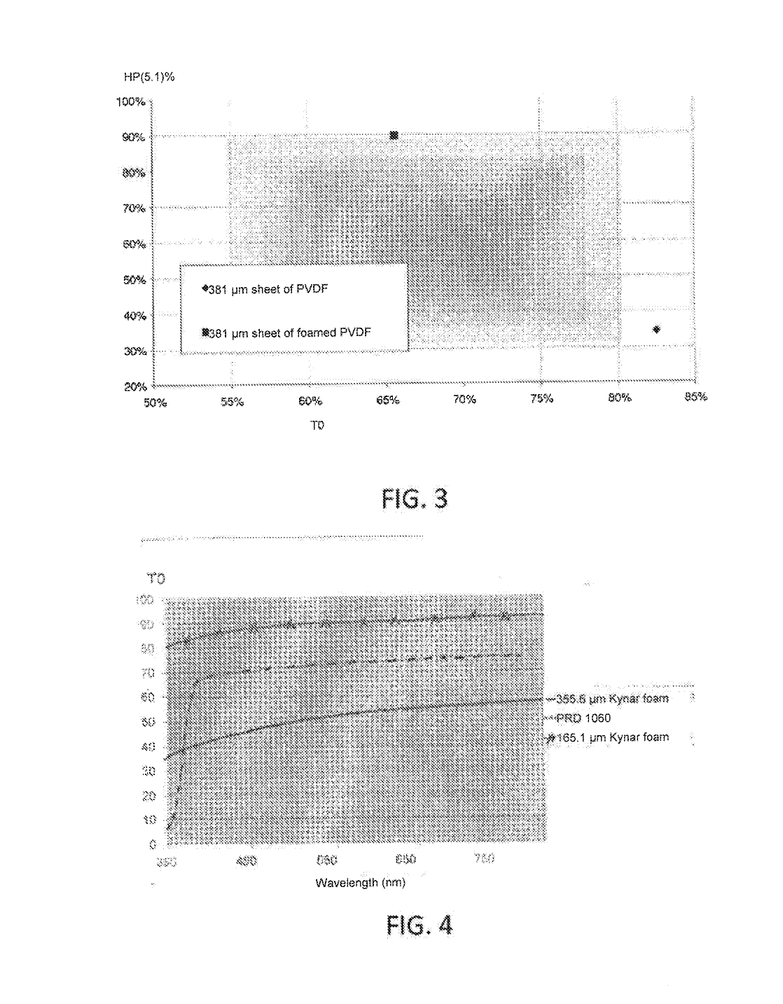

The results seen in FIG. 4 are obtained for sheets of foamed KYNAR FLEX® obtained by extrusion. The measurements were carried out with a Lambda 950 device. The light source is an illuminant of type A as defined by the International Commission on Illumination.

PRD 1060 refers to a commercial lens made of Plexiglas® (i.e. made of polymethyl methacrylate) having a thickness of 2032 μm.

The lower solid-line curve represents the degree of transmission of light as a function of the wavelength thereof for a 355.6 μm sheet of foamed KYNAR FLEX®. For a wavelength of 350 nm, the degree of transmission is around 35%. It increases steadily, reaching the value of 57% at 850 nm.

The dotted-line curve represents the degree of transmission of light as a function of the wavelength thereof for a PRD 1060 lens. For a wavelength of 350 nm, the degree of transmission is around 5%. It increases abruptly up to 400 nm, reaching the value of 68% and then increases steadily, reaching the value of 78% at 850 nm. The upper curve which comprises crosses represents the degree of transmission of light as a function of the wavelength thereof for a 165.1 μm thick sheet of foamed KYNAR FLEX®. For a wavelength of 350 nm, the degree of transmission is around 80%. It increases steadily, reaching the value of 90% at 850 nm.

As represented in FIG. 4, the degree of transmission of light is always greater for the 165.1 μm thick sheet of foamed KYNAR FLEX®. The curve corresponding to the commercial lens bisects that of the 355.6 μm sheet of foamed KYNAR FLEX® at wavelengths between 350 and 450 nm.

The results from FIG. 4 show that, by a judicious choice of the thickness of the PVDF foam, it is possible to obtain optical properties identical to that of a commercial lens, with however a higher transmission around 350 nm. The other major advantage is that the PVDF foam is fire resistant, which is not the case for the PMMA lens.

Table I below assembles the values of the hiding power for the various aforementioned sheets measured with an illuminant of type A as mentioned above, as light source, for n=5.1 cm.

TABLE I

| | Thickness | Transmission (%) | | Hiding power |
|---|---|---|---|---|
| Material | μm | T0 | T(5.1) | HP(5.1)% |
| KYNAR FLEX ® | 165.1 | 89.8 | 33.9 | 62.2 |
| foam | | | | |
| KYNAR FLEX ® | 355.6 | 51.7 | 4.4 | 91.5 |
| foam | | | | |
| PRD 1060 | 2032 | 72.8 | 7.8 | 89.3 |

The results from table E show that the use of a fluoropolymer foam for the manufacture of an optical diffuser makes it possible to obtain a better hiding power with a thinner sheet.

### Influence of the Density on the Optical Properties

Measurements of the hiding power at n=2.5 cm and at n=5.1 cm were carried out with a BYK-Gardner haze meter in order to determine the influence of the density of the fluoropolymer foam. The light source used is an illuminant of type A as mentioned above. In table II, the optical properties of two foams are compared. The 0.51 mm sheet of KYNAR FLEX® foam (referenced foam I) has a density of 1.42. The 0.76 mm sheet of KYNAR FLEX® foam (referenced foam II) has a density of 1.19.

The results obtained are assembled in table II below.

TABLE II

| Sample | T0 (%) | T(2.5)(%) | T(5.1)(%) | HP(2.5)(%) | HP(5.1)(%) |
|---|---|---|---|---|---|
| Foam I | 57.0 | 13.5 | 4.7 | 76 | 92 |
| Foam II | 61.0 | 13.2 | 4.4 | 78 | 93 |

The results from table II above show that, for substantially the same hiding power (HP(2.5) or HP(5.1)), foam II has a better transmittance despite its greater thickness.

The aforementioned results show that it is possible, by adjusting certain parameters such as the thickness of the diffusing portion and the density of the solid fluoropolymer foam, to obtain an optical diffuser of which the diffusing portion achieves a more than satisfactory compromise between hiding power and the degree of transmission of light emitted by the light source.

Furthermore, all the results obtained relate to sheets obtained by extrusion. However, a person skilled in the art knows that the optical quality of extruded sheets is worse than that of sheets obtained by injection. Results that are at least equivalent will be obtained for sheets obtained by injection.

1. An optical diffuser having a diffusing portion capable of being passed through by the luminous flux emitted by a point light source, when said optical diffuser is mounted on said point light source, wherein said diffusing portion is formed from a solid foam comprising at least one fluoropolymer, said fluoropolymer being a copolymer of vinylidene fluoride (VDF) with a fluorinated cornonomer selected from the group consisting of chlorotrifluoroethylene (CTFE), hexafluoropropylene (HFP), trifluoroethylene (VF₃), tetrafluoroethylene (TFE) and mixtures thereof.

2. The optical diffuser as claimed in claim 1, wherein said copolymer comprises only VDF and HFP.

3. The optical diffuser as claimed in claim 2, wherein said VDF-HFP copolymer contains at least 50% by weight of VDF.

4. The optical diffuser as claimed in claim 1, wherein said foam contains, in addition, an acrylic polymer, especially polymethyl methacrylate.

5. The optical diffuser as claimed in claim 4, wherein said foam contains a weight fraction of acrylic polymer of between 0.1 and 90%, relative to the total weight of the acrylic polymer-vinylidene fluoride mixture.

6. The optical diffuser as claimed in claim 1, wherein said diffusing portion has a thickness substantially equal to or greater than 100 μm and substantially less than or equal to 2 mm and in particular a thickness substantially equal to or greater than 150 μm and substantially less than or equal to 1 mm.

7. The optical diffuser as claimed in claim 1, wherein said diffusing portion has a hiding power HP(5.1) % measured according to the integrating sphere method that is substantially equal to or greater than 80% and in particular substantially equal to 90%.

8. The optical diffuser as claimed in claim 1, wherein said diffusing portion transmits, in the wavelengths of the visible spectrum, at least 50% of the light emitted by said point light source.

9. A light-emitting device comprising a point light source, and said optical diffuser as claimed in claim 1.

10. The light-emitting device as claimed in claim 9, wherein said point light source is a light-emitting diode.

11. The light-emitting device as claimed in claim 3, wherein said VDF-HFP copolymer contains at least 75% by weight of VDF.

12. The light-emitting device as claimed in claim 11, wherein said VDF-HFP copolymer contains at least 80% by weight of VDF.

13. The optical diffuser as claimed in claim 8 wherein said diffusing portion transmits, in the wavelengths of the visible spectrum, at least 65% of the light emitted, by said point light source.
